(19) United States
(12) Patent Application Publication
(10) Pub. No.: US 2008/0216137 A1
(43) Pub. Date: Sep. 4, 2008

(54) Triggering Enhanced Content

(76) Inventor: Wilhelm Adriaan Carolus Van Der Heijden, Pj's-Hertogenbosch (NL)

Correspondence Address: HARRINGTON & SMITH, PC, 4 RESEARCH DRIVE, SHELTON, CT, 06484-6212, US

(21) Appl. No.: 11/597,387

(22) PCT Filed: May 20, 2005
(86) PCT No.: PCT/IB05/01854

§ 371 Date: Jan. 7, 2008

(30) Foreign Application Priority Data
May 25, 2004 (GB) 0411683.6

(51) Int. Cl. H04N 7/173

(52) U.S. Cl. 725/110

(57) ABSTRACT

A receiver for an enhanced television system in which video data defining a video stream, enhanced content data defining items of enhanced content, and trigger messages for triggering the play-out of the enhanced content are transmitted to receivers over a data network, the receiver comprising an enhanced content decoder for receiving and playing out enhanced content, and the enhanced content decoder including a cache for caching enhanced content data received from the network; and a play-out controller for controlling the play-out of enhanced content, the play-out controller being arranged to receive trigger messages over the network and on receiving a trigger message that indicates an item of enhanced content for which enhanced content data is stored in the cache and that is to be played out, to play out that item of enhanced content data at a time indicated by the trigger message, and on receiving a trigger message that includes a definition of enhanced content, to play out the enhanced content defined in the trigger message at a time indicated by the trigger message.

This invention relates to triggering enhanced content in an enhanced television system.

In an enhanced television (eTV) system a television program is transmitted to a viewer together with enhanced content. The enhanced content is normally intended to accompany the programme and could include additional information for the viewer in the form of text, graphics and embedded items such as audio and video clips. Normally the viewer has a set-top box or an equivalent device which receives and interprets the enhanced content and presents it to a user in accordance with inputs received from the user. The set-top box may also be able to return data to the provider of the television program in accordance with user inputs.

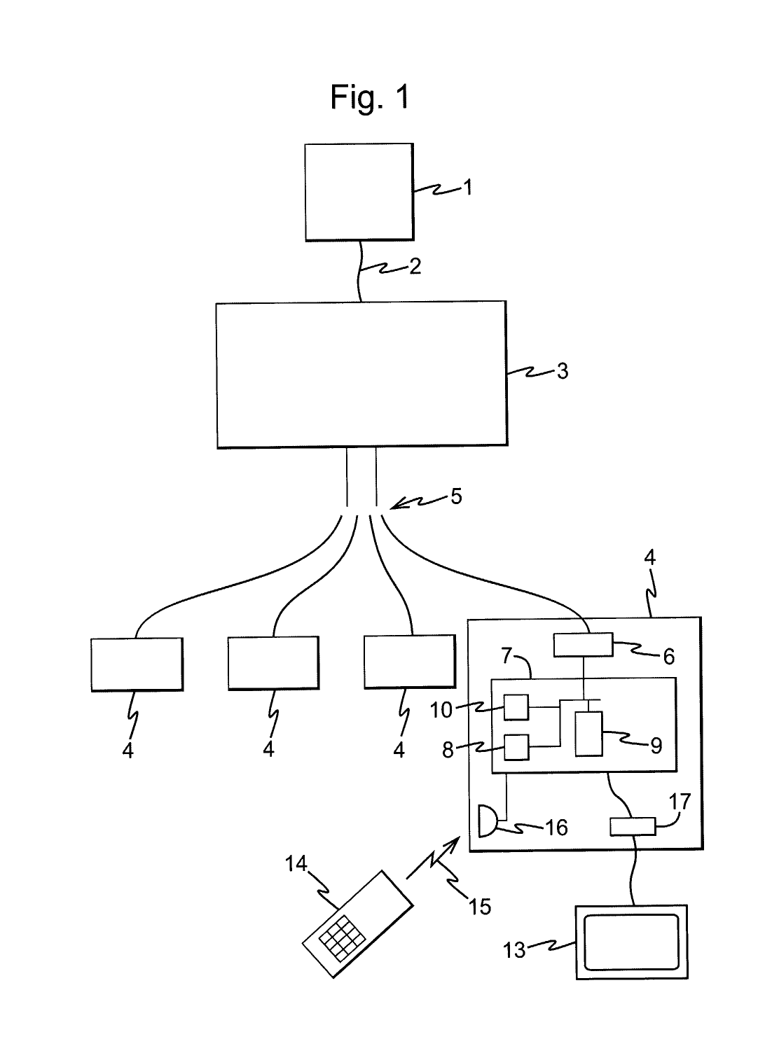

FIG. 1 shows such a system schematically. The system comprises a programming section 1, which could be operated by a television programme provider. This generates a feed of an enhanced TV programme comprising a television (video and audio) stream and associated enhanced content. The programme is provided over link 2 to a transmission system 3. The transmission system 3 is able to transmit the programme to viewers' own receiving devices. In this example, the viewers' receiving devices are set-top boxes 4, which are connected to the transmission system via a cable link 5; but other mechanisms such as satellite and terrestrial broadcasting could be used to provide the feed to the receiving devices. When the programme is received at the transmission system the transmission system converts the program into a form that can be interpreted by the type of receiving device to which it will transmit the program. If the programme is received at the transmission system before it is scheduled for transmission to viewers then the transmission system caches the programme accordingly.

When the programme is to be transmitted to viewers the transmission system transmits the programme and the enhanced content over the cable link 5 to the set-top boxes 4.

One of the set-top boxes 4 is shown in more detail. The data including the programme is received by a cable interface 6 which performs transport level decoding and in turn provides the data to a processing section 7. The processing system comprises a temporary data memory (e.g. RAM) 8, a CPU 9 and a permanent data store 10, such as a hard disk. The CPU executes operating program instructions stored in data store 10. When programme data is received from interface 6 the CPU interprets that data according to the stored operating program. The television stream is decoded from the format in which it was sent over the cable link and is passed via video interface 11 over connection 12 to television 13, where it is presented to a viewer. Enhanced content is also decoded and is presented to a viewer in accordance with the operating program. The enhanced content could be provided in a form such as HTML (including HTML page code, and associated data files such as graphics and audio). In that case the operating program would interpret the HTML code to form graphics pages which it could transmit over connection 11 for display by the television in conjunction with or instead of the television stream. Alternatively the enhanced content could be provided in the form of an application program which would be stored in temporary memory 8 and then executed directly by the CPU 9.

The user can provide input to the set-top box by means of remote controller 14, which can transmit data to the processing section 7 of the set-top box over wireless link 15 and via wireless interface 16. Such input could control the set-top box, or software running on it, or could provide inputs in response to enhanced content data presented by the set-top box. Such responses could be passed to the transmission system 3 by the set-top box, for example via a return channel of the cable link 5. Thus the viewers' responses can provide feedback to the transmission system.

The set-top boxes also have a video output interface 17 whereby they can provide a video feed to a television 18.

Because the bandwidth available for transmission of the enhanced content to set-top boxes is normally limited, the enhanced content is normally transmitted to set-top boxes in advance of its presentation to viewers. The presentation of the enhanced content is controlled by several means. First, the user can select to view or not view the enhanced content by providing appropriate inputs to the set-top box. Second, the provision of the enhanced content to a viewer is influenced by triggers which are sent to the set-top box by the processing section 3 over link 5. When the enhanced content is in HTML form, a trigger that specifies a specific page that has already been received by the set-top box can trigger the processing section 7 to present that page to the viewer when the trigger is received at the set-top box. When the enhanced content is the form of an executable, a trigger that specifies a certain code can trigger the executable to present data that is associated with that code to the viewer when the trigger is received at the set-top box. Hence triggers can be used to synchronise enhanced content data to events in the running of the television programme.

One application for enhanced TV systems is the provision of interactive quiz shows to viewers. In an interactive quiz show the viewer could be presented with a question in the television stream and/or in the enhanced content, and could provide a response through the enhanced content. For example, in the television stream a quiz show host could read out a question, and an accompanying enhanced content page could indicate multiple choice answers to the question. Using his remote control a viewer could select to view the enhanced content and then indicate his choice of answer. The choice of answer could be returned to the transmission system 3, which could process the answers received from all viewers and select a winner who could receive a prize.

After the time for answering the question has expired, it is desirable for the enhanced TV system to be able to show the viewer the correct answer by the enhanced content. In conventional enhanced TV systems, in which enhanced content is downloaded to set-top boxes in advance of being presented to viewers and then presented when a corresponding trigger is received, this can be done by including the answers in enhanced content that is downloaded to the set-top boxes in advance. For example, where the enhanced content for the quiz show is provided by an executable that is downloaded to the set-top box, that executable can include data defining enhanced content for presenting the questions to viewers and for presenting the answers when triggered to do so. However, this approach has several problems. First, it is possible that the answers to the questions are not known in advance: for example in the case of questions regarding the outcome of a live event that is shown in the television stream. Second, when prizes are to be awarded based on the outcome of the quiz it is undesirable for the answers to be transmitted in advance because a malicious user might be able to cheat by extracting the answers from the transmitted data.

It might be possible for data defining the pages of enhanced content that include the answers to be sent to set-top boxes after the time for answering the question has expired. However, this is not desirable because of the limited bandwidth that is typically available. The resulting delay could make the presentation to the viewer seem disjointed. Also, this would contradict the normal data transmission scheme.

There is therefore a need for an improved method of providing enhanced content data, especially in the case of quiz shows and similar applications.

According to one aspect of the present invention there is provided a receiver for an enhanced television system in which video data defining a video stream, enhanced content data defining the content of a plurality of items of enhanced content, and trigger messages for triggering the play-out of the enhanced content are transmitted to receivers over a data network, the receiver comprising an enhanced content decoder for receiving and playing out enhanced content, and the enhanced content decoder comprising: a cache for caching enhanced content data received from the network; and a play-out controller for controlling the play-out of enhanced content, the play-out controller being arranged to receive trigger messages over the network and on receiving a trigger message that indicates an item of enhanced content for which enhanced content data is stored in the cache and that is to be played out, to play out that item of enhanced content data at a time indicated by the trigger message, and on receiving a trigger message that includes a definition of enhanced content, to play out the enhanced content defined in the trigger message at a time indicated by the trigger message.

A method for operating an enhanced television system in which video data defining a video stream, enhanced content data defining items of enhanced content, and trigger messages for triggering the play-out of the enhanced content are transmitted to receivers over a data network, the receiver comprising an enhanced content decoder for receiving and playing out enhanced content, the method comprising: transmitting items of enhanced content over the network to the receivers; caching the items of enhanced content at the receivers; commencing transmission of a video stream to the receivers over the network; transmitting to the receivers at least one trigger message that also includes a definition of enhanced content; and playing out the enhanced content defined in the trigger message by means of the receivers at a time indicated by the trigger message.

Preferably the enhanced content data comprises data in mark-up language format defining the enhanced content, and the play-out controller comprises a processor and a program memory for storing instructions for execution by the processor to decode that enhanced content data. That program memory may be non-volatile memory. The trigger message that includes a definition of enhanced content may include that definition in mark-up language format. The mark-up language may be HTML.

Alternatively, the enhanced content and/or the trigger message that includes a definition of enhanced content may include that definition in a format executable by the processor.

The play-out controller is preferably arranged to, on receiving a trigger message that indicates an item of enhanced content for which enhanced content data is stored in the cache and that includes a definition of enhanced content, merge that item of enhanced content data and the enhanced content defined in the trigger message to form a merged item of enhanced content and play out the enhanced content defined in the trigger message at a time indicated by the trigger message.

The time indicated by a trigger message is preferably the time at which it is received at the receiver.

The enhanced content defined in the trigger message may comprise real-time information. Alternatively, or in addition, the enhanced content defined in the trigger message comprises information for the indication of which in the enhanced television system prior to receipt of the trigger message at the receiver a value has been offered. Similarly, the method may comprise offering value for indication of the information in the enhanced television system prior to receipt of the trigger message at the receiver. The value may be money or money's worth. The value may be conditional on other steps, such as a random draw.

The receiver may comprise a video decoder for receiving video data from the network and outputting the video stream defined by that data in a form suitable for display by a television. The receiver may be capable of playing out an item of enhanced content by presenting it to the television.

The item of enhanced content may be in the form of a page of information to be presented to a user. The item of enhanced content may include information defining a question, together optionally with multiple selectable answers to that question. The said information in the trigger message may be information for visual and/or audio presentation to a user. That information may be an answer, preferably an answer to the said question.

The present invention will now be described by way of example, with reference to the accompanying drawings.

In the drawings:

FIG. 1 is a schematic diagram of an enhanced television system;

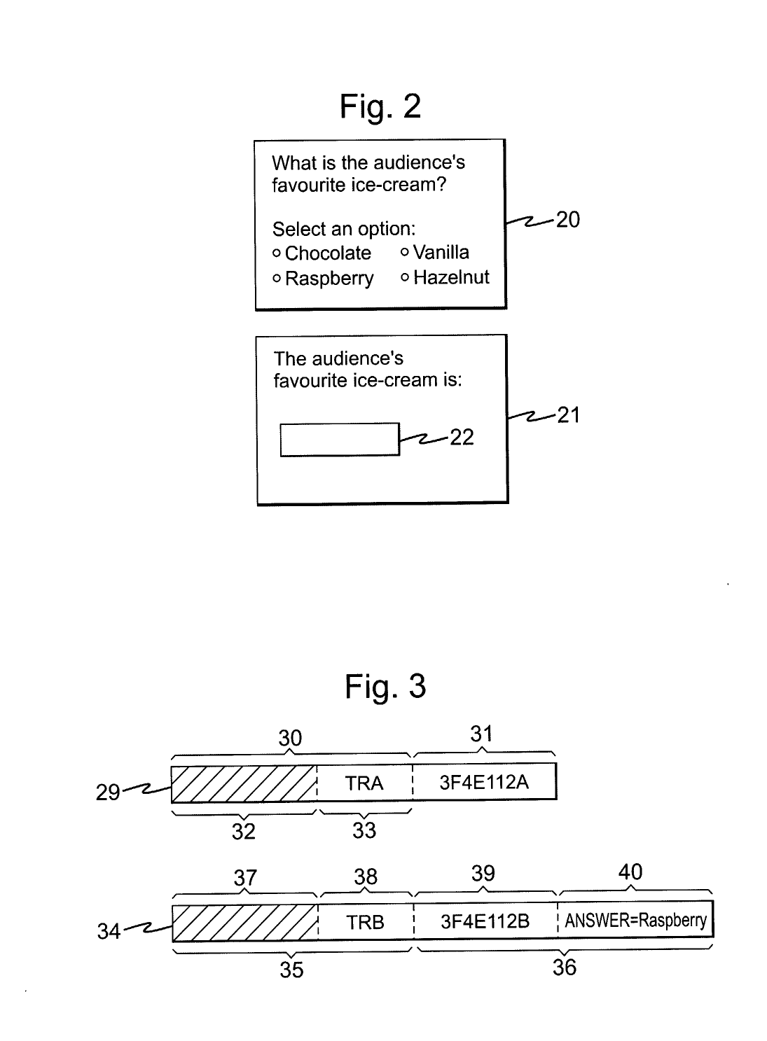

FIG. 2 illustrates enhanced content;

FIG. 3 shows data transmitted to set-top boxes; and

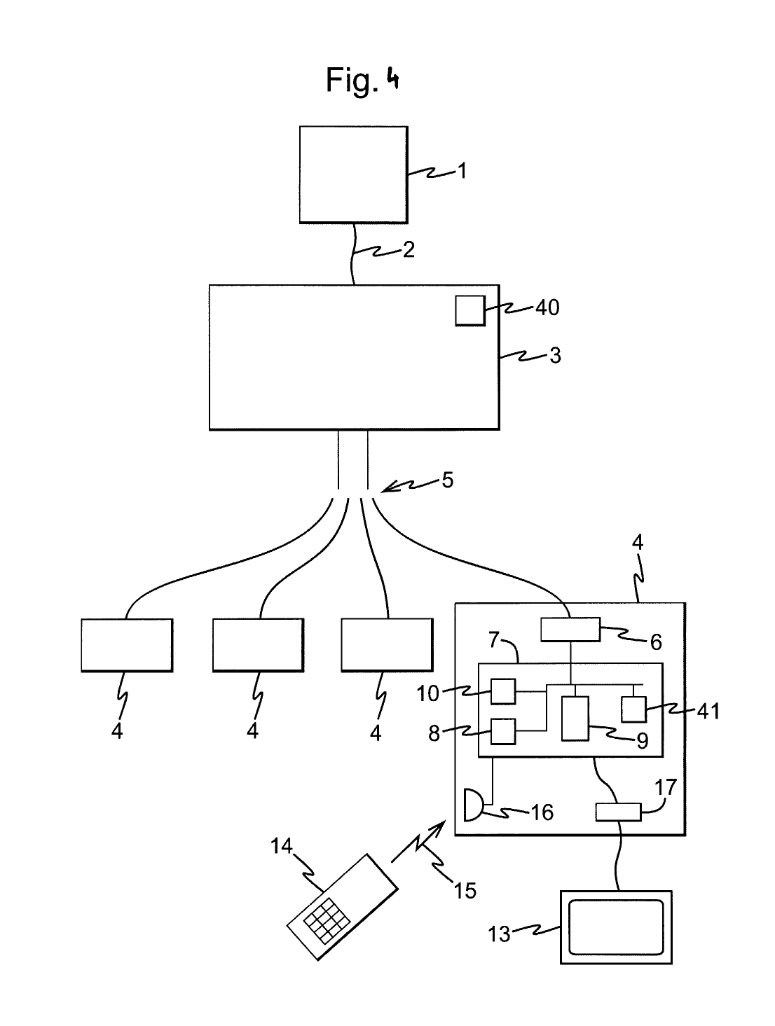

FIG. 4 is a schematic diagram of an enhanced television system.

In the systems to be described below, enhanced content is transmitted to set-top boxes or other suitable receivers, which cache the enhanced content. Subsequently trigger messages are transmitted to the set-top boxes to trigger them to play out cached enhanced content. Each trigger message identifies an item of the enhanced content. Reception of a trigger message at a set-top box triggers that set-top box to play out the enhanced content identified in the trigger message.

A trigger message may furthermore include a definition of enhanced content. That definition may be provided in the message in a number of ways, as discussed in more detail below. Reception at a set-top box of a trigger message that includes a definition of enhanced content triggers that set-top box to play out that enhanced content.

As an example of the operation of the system an application involving an interactive quiz show will be described.

In this example, enhanced content representing a series of pages for display is transmitted to set-top boxes in advance of the broadcast of a quiz show. The pages may be defined in HTML (hypertext mark-up language) or any other language in which enhanced content can be interpreted by the set-top boxes. The pages include text and graphics and may also include video and audio clips and items of any other relevant media. At least some of the pages include text indicating questions, and offering a number of answers. FIG. 2 shows an example of one such page at 20. The questions relate to real-time subject matter such as: “What is the audience's favourite ice-cream?”, and so the answers to the questions are not known in advance. At least some of the pages include text indicating answers. FIG. 2 shows an example of one such page at 21. In this page there is a blank at 22 where the answer is to appear. These pages include a definition of a variable field where the answer is to appear. For example, they could include the fragment:
“The answer is <%=ANSWER%>.”,
   where the symbols “<%” and “%>” enclose embedded code and the code “=ANSWER” indicates that the content of variable ANSWER is to be inserted.

Each page may have a unique identity (ID) code.

When the event is broadcast, trigger messages are sent to the set-top boxes from time to time. Each trigger message is transmitted when (or so as to be received by the set-top boxes when) an item of enhanced content that is identified in the message is to be presented to users. For instance, the host of the quiz show, who is shown in the video that is being broadcast, might say: “Here is tonight's first interactive question”. As that action is being broadcast a trigger message specifying the ID code of an item of enhanced content such as page 20 may be sent to trigger the presentation of that item to users. A viewer who has selected to view enhanced content by configuring his set-top box accordingly will then see the page 20. He can then select an answer, and may also be able to have his set-top box transmit his answer to the network.

When the answer to the question is known, a trigger message is sent to the set-top boxes to trigger the play-out of the appropriate answer page. This trigger message also includes data that defines enhanced content that is to appear. In this example, if the message is to trigger play-out of page 21, it includes a definition of the variable ANSWER, for example: “ANSWER=Raspberry”.

In this way the enhanced content can be adapted during play-out to take account of events that have taken place after the pages themselves have been transmitted to the set-top boxes.

The trigger messages are of a predefined format that indicates them as being trigger messages. In one example, each message transmitted over the system includes a type field, the content of which indicates the type of the message. Trigger messages are distinguished from other messages by the presence of one or more distinct sets of content in that type field. FIG. 3 illustrates two types of trigger message. In message 29 there is a header 30 and a payload 31. The header includes a transport section 32, which comprises data required for transport and decoding of the message (for instance a source ID, message length and a CRC check) and a type field 33. In this example the content of type field 33 is “TRA”, which indicates that the message is a type A trigger message. A type A trigger message has been predefined as being of a format wherein the payload consists of an indication of an item of enhanced content that is to be played out. In this example that indication is the identity code of an item of enhanced content: “3F4E112A”. In message 34 there is a header 35 and a payload 36. The header includes a transport section 37, which is of the same format as transport section 32 and a type field 38. In this example the content of type field 38 is “TRB”, which indicates that the message is a type B trigger message. A type B trigger message has been predefined as being of a format wherein the payload consists of an indication of an item of enhanced content that is to be played out together with a definition of enhanced content. In this example the indication 39 is the identity code of an item of enhanced content: “3F4E112B” and the definition 40 is “<ANSWER=Raspberry>”.

The data flow during operation of the system will now be described in more detail with reference to FIG. 4. FIG. 4 shows a system generally of the form shown in FIG. 1, but with modifications to permit the operation of the present invention. Like parts are numbered in FIG. 4 as in FIG. 1.

For the broadcasting of a programme in a system of the type shown in FIG. 4, the following events will occur in order:

1. The broadcasting of the event starts, on a predetermined channel of the network. This involves the transmission system 3 transmitting the pages of enhanced content to set-top boxes, where they are cached for presentation later; and the transmission system beginning to broadcast the video stream.
2. The media control manager (MCM) is enabled for play-out of the eTV-application related to the programme.
3. A viewer decides to play along with the eTV-application and accordingly configures his set-top box to cause his television to show video from the appropriate channel stream and to present enhanced content for that channel.
4. At the appropriate time, the MCM broadcasts a trigger message for a page of enhanced content that defines the presentation of a question to the user. The trigger message includes the ID of that page. When this trigger message is received at the viewer's set-top box it is interpreted by the CPU 9, which controls the set-top box to present the page to the user.
5. The user may then interact with the page, for example by selecting and/or entering an answer to the question (for example by means of his remote control). An answer that has been entered may be transmitted back to the network for processing, as will be described below.
6. The answer is determined at the network. This may be done by a network operator entering the answer when he knows it into the MCM (for example if the question relates to a real-time event such as “Which horse will win the next race?”) or by processing received answers at the network (this may in particular be appropriate when the question is in the form of a poll to determine which of the available answers is the most popular with the audience). When the answer is known it is provided to an answer processing unit 40 in the transmission system 3.
7. The answer processing unit 40 forms a trigger message that includes the answer in a form suitable for interpretation and presentation to users by the set-top boxes. The exact operation of the answer processing unit will depend on the language used by the set-top boxes, but in most cases it need only insert the answer as plain text at the appropriate point in a pre-prepared message. The trigger message formed by the answer processing unit includes the ID of the page in which the answer is to be inserted. At the appropriate time, the MCM broadcasts the trigger message formed by the answer processing unit.
8. When this trigger message is received at the viewer's set-top box it interprets the message, by its type, as including a definition of enhanced content. A page linker 41 builds a page by combining the cached definition of the page identified in the message with the enhanced content defined in the message. The exact operation of the page linker will depend on the language used by the set-top box, but in most cases it need only insert the payload of the trigger message at the appropriate point in the page or executable. Once the page linker has formed the page it presents it to the viewer.
9. Steps 4 to 8 might be repeated a number of times for subsequent questions.
10. The MCM deactivates the play-out of the eTV-application.

The enhanced content defined in the trigger messages may be provided in a number of ways. One way is as described above, in which the enhanced content defined in the trigger message is provided as one or more blocks of data to be inserted into an item of enhanced content that is pre-existing at the set-top box. In that way the data in the trigger message and the pre-existing item together define the content that is to be presented. Another way is appropriate to set-top boxes where the enhanced content is provided in the form of executable code. In that system, the trigger messages can include procedures (resources) that are to be called at the appropriate point in the execution of the code.

Where the enhanced content is delivered as an executable resource (e.g. that includes or may include conditionally actionable instructions) it can be used in at least two ways:

1. The resource can carry a definition of a single correct answer (i.e. one “answer-resource” per question);
2. The resource can carry multiple correct answers (i.e. a single “answer-resource” containing the answers to all or multiple questions).

In the former case the sequence of events that take place in the operation of the system can be analogous to that described above. In the latter case, the MCM can transmit to set-top boxes in step 1 answer resources that include definitions of multiple items of enhanced content, each of which corresponds to a respective answer. Then at step 8 the page linker selects one of those items based on the payload of the trigger message transmitted at step 7. This approach is most suitable for multiple choice questions. This approach may also be used when the enhanced content is not delivered as an executable, but then it is less likely to be the most efficient approach.

It should be noted that the order of the events can be varied. For instance, the answer resource could be transmitted to set-top boxes after the trigger to present the question has been transmitted. In a programme that includes several questions, a single answer-resource defining enhanced content corresponding to the answers to all those questions could be sent at the beginning. The answer triggers could all be sent at the end of the programme, or combined into a single answer trigger that is sent then.

The above schemes allow the definitions of answers to be transmitted to set-top boxes during the broadcasting of a programme, and within existing messaging structures.

Where a set-top box is to provide an answer to the network, it can be done in the following way. The enhanced content includes a definition of one or more input fields whereby a user can provide input to the set-top box. This may be done as an HTML form, or in another way suitable to the set-top box. Using an input device of the set-top box (e.g. a remote control) the user enters data into the form, for example by filling in a text field or selecting one or more buttons. The set-top box then returns that input to the network using a suitable return channel. The return channel could be a dedicated uplink in a cable television system, or a phone line linked to a modem in a satellite broadcast television system. The message returned by the set-top box includes the identity of the set-top box so that, for instance, if a prize is to be awarded it can go to the right user.

The system can operate with multiple types of set-top boxes, which each interpret different types of content. By suitable design of the content and the set-top boxes' page linkers the same trigger messages could be used correctly by all the set-top boxes.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A receiver for an enhanced television system in which video data defining a video stream, enhanced content data defining the content of a plurality of items of enhanced content, and trigger messages for triggering the play-out of the enhanced content are transmitted to receivers over a data network, the receiver comprising an enhanced content decoder for receiving and playing out enhanced content, and the enhanced content decoder comprising:
a cache for caching enhanced content data received from the network; and
a play-out controller for controlling the play-out of enhanced content, the play-out controller being arranged to receive trigger messages over the network and
on receiving a trigger message that indicates an item of enhanced content for which enhanced content data is stored in the cache and that is to be played out, to play out that item of enhanced content data at a time indicated by the trigger message, and
on receiving a trigger message that indicates an item of enhanced content for which enhanced content data is stored in the cache and that includes a definition of enhanced content, merge that item of enhanced content data and the enhanced content defined in the trigger message to form a merged item of enhanced content and play out the enhanced content defined in the trigger message at a time indicated by the trigger message.

2. A receiver as claimed in claim 1, wherein the enhanced content data comprises data in mark-up language format defining the enhanced content, and the play-out controller comprises a processor and a program memory for storing instructions for execution by the processor to decode that enhanced content data.

3. A receiver as claimed in claim 2, wherein the program memory is non-volatile memory.

4. A receiver as claimed in claim 2, wherein the trigger message that includes a definition of enhanced content includes that definition in mark-up language format.

5. A receiver as claimed in claim 2, wherein the mark-up language is HTML.

6. A receiver as claimed in claim 2, wherein the trigger message that includes a definition of enhanced content includes that definition in a format executable by the processor.

7. A receiver as claimed in claim 1, wherein the play-out controller is arranged to, on receiving a trigger message that includes a definition of enhanced content, to play out the enhanced content defined in the trigger message at a time indicated by the trigger message.

8. A receiver as claimed in claim 1, wherein the time indicated by a trigger message is the time at which it is received at the receiver.

9. A receiver as claimed in claim 1, wherein the enhanced content defined in the trigger message comprises real-time information.

10. A receiver as claimed in claim 1, wherein the enhanced content defined in the trigger message comprises information for the indication of which in the enhanced television system prior to receipt of the trigger message at the receiver a value has been offered.

11. A receiver as claimed in claim 1, comprising a video decoder for receiving video data from the network and outputting the video stream defined by that data in a form suitable for display by a television.

12. A receiver as claimed in claim 11, wherein the receiver is capable of playing out an item of enhanced content by presenting it to the television.

13. A method for operating an enhanced television system in which video data defining a video stream, enhanced content data defining items of enhanced content, and trigger messages for triggering the play-out of the enhanced content are transmitted to receivers over a data network, the receiver comprising an enhanced content decoder for receiving and playing out enhanced content, the method comprising:
transmitting items of enhanced content over the network to the receivers;
caching the items of enhanced content at the receivers;
commencing transmission of a video stream to the receivers over the network;
transmitting to the receivers at least one trigger message that also includes a definition of enhanced content; and
playing out the enhanced content defined in the trigger message by means of the receivers at a time indicated by the trigger message.

14. A method as claimed in claim 13, wherein the enhanced content defined in the trigger message includes information, and the method comprises:
offering value for indication of the information in the enhanced television system prior to receipt of the trigger message at the receiver.
